(19) United States
(12) Patent Application Publication
(10) Pub. No.: US 2025/0026132 A1
(43) Pub. Date: Jan. 23, 2025

(54) LIQUID DISCHARGE APPARATUS

(71) Applicant: Masanori HIRANO, Kanagawa (JP)

(72) Inventor: Masanori HIRANO, Kanagawa (JP)

(21) Appl. No.: 18/772,595

(22) Filed: Jul. 15, 2024

(30) Foreign Application Priority Data
Jul. 18, 2023 (JP) 2023-116784

(51) Int. Cl. B41J 2/21; B41J 11/00

(52) U.S. Cl. CPC B41J 2/2103; B41J 2/2117; B41J 2/2132; B41J 11/007

(57) ABSTRACT

A liquid discharge apparatus includes multiple heads including a first head to discharge a pretreatment liquid onto a medium in resolution N1, a second head to discharge a white ink onto the medium in resolution N2, and a third head to discharge a color ink onto the medium in resolution N3, multiple carriages, and a conveyor. Expressions of N1≥N2≥N3, N1/N3=m, N2/N3=n, and m≥n are satisfied. The conveyor intermittently conveys the medium by an amount of line feed W of the medium in response to one movement of the third head. The first head is arranged at a first distance L1 from the second head, and the second head is arranged at a second distance L2 from the third head. Expressions of L1=W×p, and L2=W×q are satisfied.

### CROSS-REFERENCE TO RELATED APPLICATION

This patent application is based on and claims priority pursuant to 35 U.S.C. § 119 (a) to Japanese Patent Application No. 2023-116784, filed on Jul. 18, 2023, in the Japan Patent Office, the entire disclosure of which is hereby incorporated by reference herein.

### BACKGROUND

### Technical Field

Embodiments of the present disclosure relate to a liquid discharge apparatus.

### Related Art

As a liquid discharge apparatus, a direct to garment (DTG) printer is known in the art. The DTG printer directly prints on a garment such as a T-shirt by an inkjet method. A certain DTG printer performs color printing after forming a foundation with white ink on a medium other than white media to form vivid color images.

### SUMMARY

Embodiments of the present disclosure describe an improved liquid discharge apparatus that includes multiple heads, multiple carriages, and a conveyor. The multiple heads include a first head to discharge a pretreatment liquid from first nozzles onto a medium in a first nozzle resolution N1; a second head to discharge a white ink from second nozzles onto the medium, onto which the pretreatment liquid has been discharged, in a second nozzle resolution N2; and a third head to discharge a color ink other than white from third nozzles onto the medium, onto which the pretreatment liquid and the white ink have been discharged, in a third nozzle resolution N3. Expressions of N1≥N2≥N3, N1/N3=m, N2/N3=n, and m≥n are satisfied, and m and n are integers equal to or greater than 1. The multiple carriages mount the multiple heads and reciprocally movable in a main scanning direction. The conveyor intermittently conveys the medium by an amount of line feed W of the medium in a sub-scanning direction orthogonal to the main scanning direction in response to one movement of the third head in the main scanning direction. The first head is arranged at a first distance L1 from the second head in the sub-scanning direction, and the second head is arranged at a second distance L2 from the third head in the sub-scanning direction. Expressions of L1=W×p, and L2=W×q are satisfied, and p and q are integers equal to or greater than 0.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIGS. 1A and 1B are schematic diagrams each illustrating a configuration of a part of a DTG printer according to an embodiment of the present disclosure;

FIGS. 2A to 2F are schematic diagrams each illustrating heads mounted on a carriage according to an embodiment of the present disclosure;

FIGS. 3A to 3C are diagrams illustrating the order of printing and a nozzle resolution of heads according to an embodiment of the present disclosure;

FIGS. 4A to 4C are diagrams illustrating the order of printing and a nozzle resolution of heads according to an embodiment of the present disclosure;

FIGS. 5A to 5E are schematic diagrams each illustrating a process of permeation of liquid discharged onto a medium;

FIGS. 6A to 6D are schematic diagrams each illustrating a process of permeation of liquid discharged onto a medium;

FIGS. 7A and 7B are diagrams each illustrating the operation of a line feed and an amount of the line feed in a printing process according to an embodiment of the present disclosure and a comparative example;

FIGS. 8A and 8B are tables in which amounts of the line feed match each other in printing using heads having different nozzle resolutions according to an embodiment of the present disclosure;

FIGS. 9A and 9B are diagrams each illustrating the relationship between an amount of line feed and an arrangement interval of heads (carriages) according to an embodiment of the present disclosure;

FIGS. 10A to 10D are diagrams each illustrating the configuration of carriages according to an embodiment of the present disclosure;

FIG. 11A is a perspective view of a liquid discharge apparatus according to an embodiment of the present disclosure; and

FIG. 11B is a front view of a liquid discharge apparatus according to an embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A liquid discharge apparatus according to embodiments of the present disclosure is described below with reference to the drawings. Embodiments of the present disclosure are not limited to the embodiments described below and may be other embodiments than the embodiments described below. The following embodiments may be modified by, for example, addition, modification, or omission within the scope that would be obvious to one skilled in the art. Any aspects having advantages as described for the following embodiments according to the present disclosure are included within the scope of the present disclosure. In the present specification, the terms “image formation,” “recording,” “printing,” and “image printing,” used herein may be used synonymously with each other.

### Overall Configuration of Liquid Discharge Apparatus

A liquid discharge apparatus according to an embodiment of the present disclosure is a serial type inkjet printer, for example, a DTG printer that forms an image on a garment (fabric) such as a T-shirt. In the following description, the liquid discharge apparatus according to the present embodiment may be referred to as the “DTG printer.”

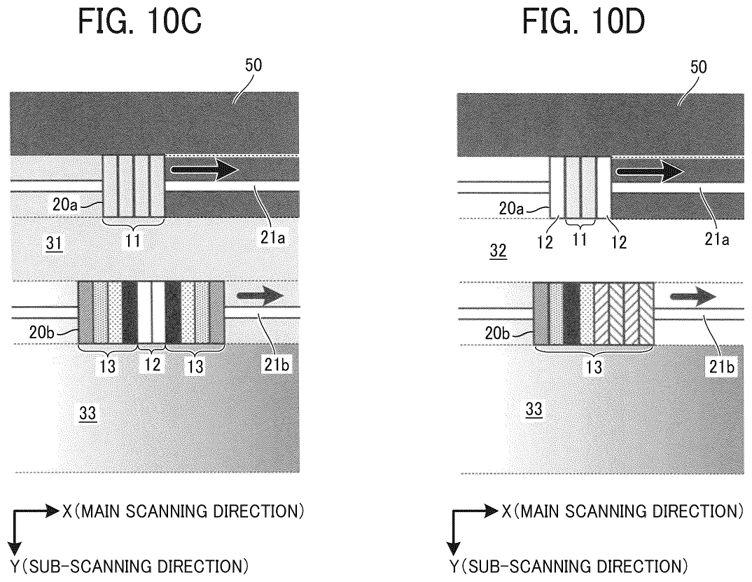

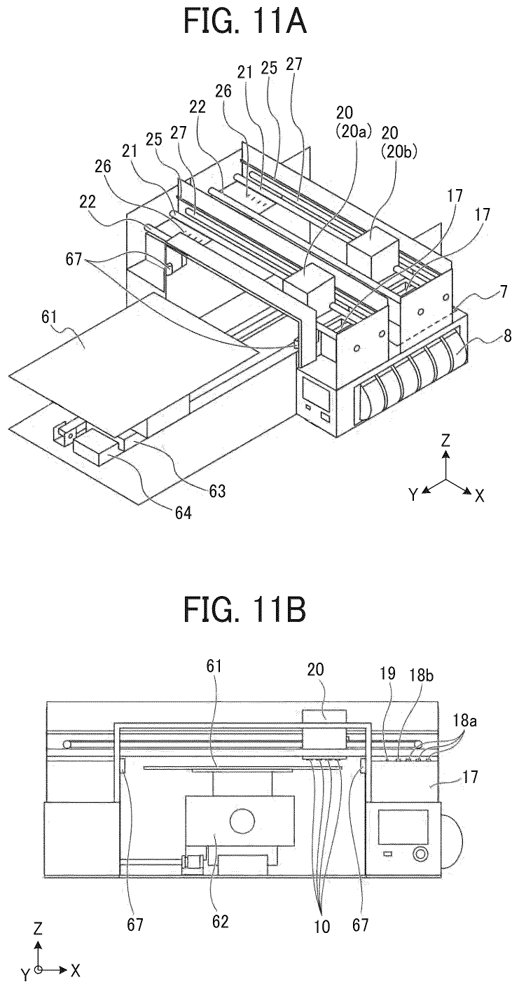

FIG. 11A is a perspective view of the liquid discharge apparatus according to the present embodiment, and FIG. 11B is a front view of the liquid discharge apparatus according to the present embodiment. In FIGS. 11A and 11B, X indicates a main scanning direction, Y indicates a sub-scanning direction orthogonal to the main scanning direction X, and Z indicates a vertical direction (also an up-down direction or a height direction) orthogonal to the main scanning direction X and the sub-scanning direction Y.

The DTG printer includes multiple heads 10, multiple carriages 20, and a conveyor (i.e., a platen 61). The multiple heads 10 are mounted on the multiple carriages 20 and discharge liquid onto a medium. The multiple carriages 20 reciprocally move in the main scanning direction X. The platen 61 intermittently conveys the medium in the sub-scanning direction Y in response to the movement (scan) of the heads 10. FIG. 11A illustrates the DTG printer including the multiple carriages 20 (two carriages 20a and 20b in this example), but the number of carriages is not limited to two and may be three or more.

The platen 61 is mounted on a lift 62, and the height of the platen 61 is adjustable in the vertical direction Z. The DTG printer having such a configuration can use media with various thicknesses. The lift 62 of the platen 61 is mounted on a slider 63. The slider 63 is movably mounted on a slider rail 64 extending in the sub-scanning direction Y. Guide rods (a guide rod 21 and a sub guide rod 22) hold the carriage 20 such that the carriage 20 is reciprocally movable in the main scanning direction X. FIG. 11A illustrates an example in which the carriage 20 is held by the main guide rod 21 and the sub guide rod 22. However, the configuration of the guide rods is not limited thereto, and the carriage 20 may be held by one guide rod.

The carriage 20 is coupled to a timing belt 27 looped around a drive pulley rotated by a main scanning motor and a driven pulley. The main scanning motor is rotatable in forward and reverse directions. The carriage 20 reciprocally moves in the main scanning direction X as the main scanning motor is driven. An encoder sheet 25 extends in the main-scanning direction X. The encoder sheet 25 has periodic slits, and the carriage 20 includes a reading sensor for reading the slits of the encoder sheet 25. Thus, the DTG printer can detect the position of the carriage 20 in the main scanning direction X from a reading result of the reading sensor.

A controller board 7 processes and controls, for example, the operation (output) of a motor and a solenoid, and an input signal of a sensor to control liquid discharge. For example, the controller board 7 performs print control of print data transmitted from a personal computer (PC) and reads print data recorded in a universal serial bus (USB) memory to perform print control processing.

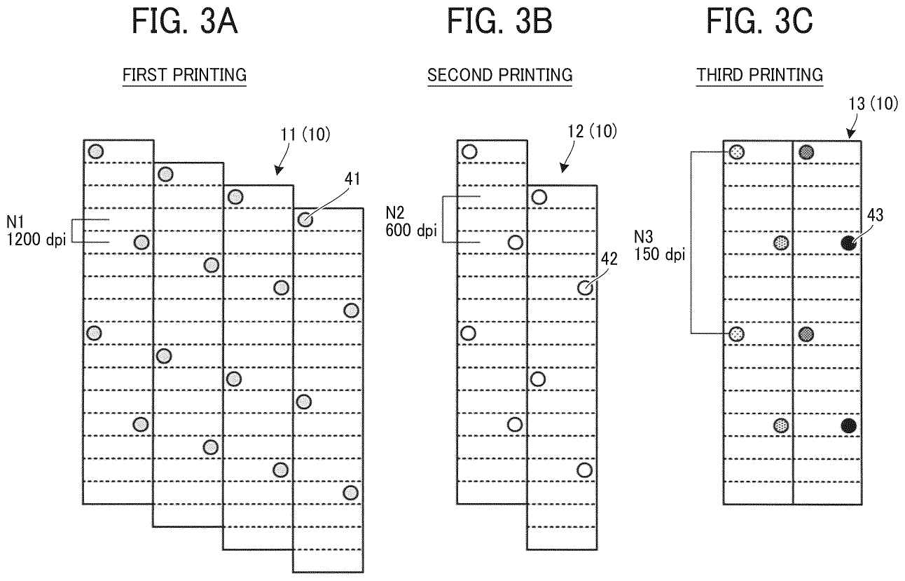

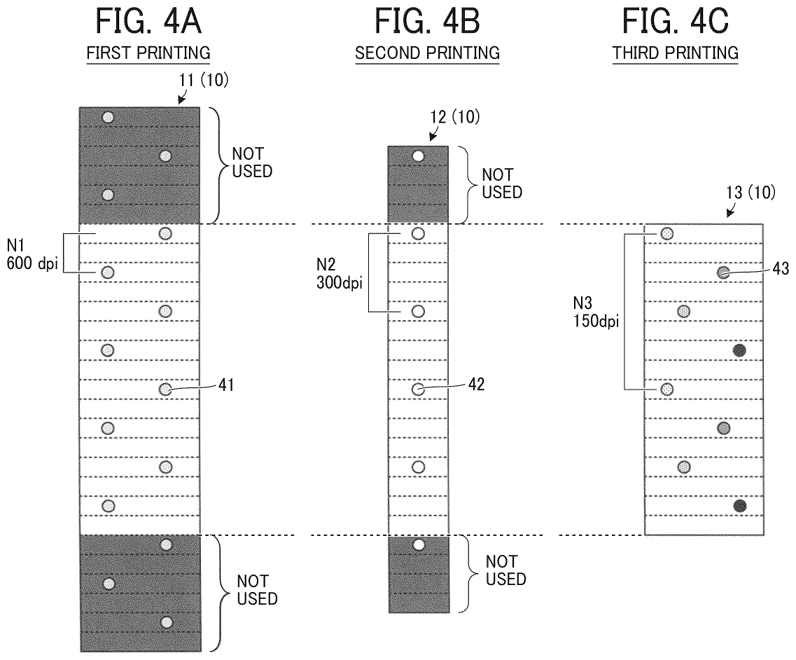

The multiple heads 10 are mounted on the carriage 20. Each head 10 has a row of multiple nozzles arranged in the sub-scanning direction (see FIGS. 3A to 4C). The carriage 20 also includes a head tank that temporarily stores ink as a liquid to be supplied to the head 10. The head tank is coupled to an ink cartridge 8 via a supply tube and a supply pump.

The DTG printer includes a detector 67 that detects the surface asperities of the medium (fabric) on the platen 61. The detector 67 is, for example, a position sensor that detects the height of the medium in the vertical direction Z. When the position sensor detects an error of the height at which the surface of the medium contacts a nozzle face of the head 10, the platen 61 is controlled to stop moving.

A maintenance unit 17 is disposed on one end of the range of movement of the carriage 20 in the main-scanning direction X to maintain and recover the head 10. The maintenance unit 17 includes a moisture-retentive cap 18a and a suction cap 18b for protecting the head 10 from drying when the DTG printer is not operating (not forming an image). The suction cap 18b is coupled to a suction pump. The maintenance unit 17 includes a wiper 19 for removing excess ink remaining on the nozzle face of the head 10 to recover the condition of the nozzles of the head 10. A discharge receptacle 26 is disposed on the other end of the range of movement of the carriage 20 in the main-scanning direction X.

When the image formation starts, the DTG printer moves the platen 61 to an image formation start position. Then, the head 10 discharges liquid while the carriage 20 moves once in the main scanning direction X. The DTG printer moves the platen 61 in the sub-scanning direction Y by a predetermined amount for the next image formation, timed to complete one movement of the carriage 20 (the head 10). The platen 61 as a conveyor intermittently conveys the medium in the sub-scanning direction Y in response to the movement (scan) of the head 10.

In the following description, an operation in which the platen 61 conveys the medium in the sub-scanning direction Y in response to the movement of the head 10 is referred to as a “line feed operation.” In addition, the distance of movement of the medium in the sub-scanning direction Y in one line feed operation (i.e., a movement distance per one time) is referred to as an amount of “line feed.”

### Configuration of DTG Printer

As illustrated in FIGS. 11A and 11B, the DTG printer according to the present embodiment includes the multiple heads 10, the multiple carriages 20, and the conveyor (i.e., the platen 61). The multiple heads 10 are mounted on the multiple carriages 20 and discharge liquid onto a medium 50. The multiple carriages 20 reciprocally move in the main scanning direction X. The platen 61 intermittently conveys the medium 50 in the sub-scanning direction Y in response to the movement (scan) of the heads 10. The carriage 20 is movably held by the guide rod 21.

In the following description, multiple heads are collectively referred to as “heads 10,” multiple carriages are collectively referred to as “carriages 20,” and multiple guide rods are collectively referred to as “guide rods 21,” each of which is referred to in the singular unless distinguished.

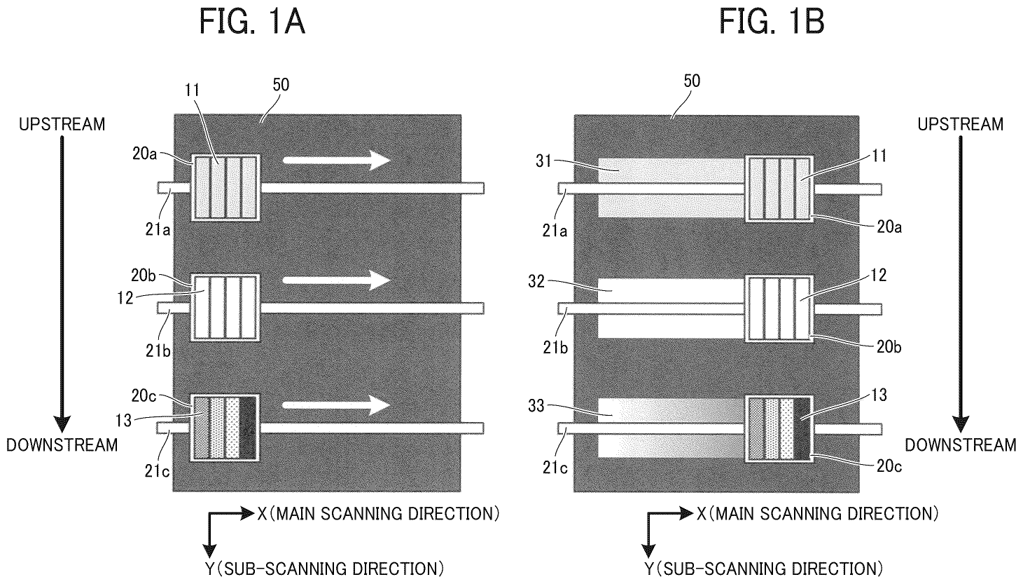

FIGS. 1A and 1B are schematic diagrams each illustrating a configuration of a part of the DTG printer according to the present embodiment. The DTG printer according to the present embodiment is a single integrated apparatus (the so-called all-in-one type apparatus) that consecutively performs the pretreatment and the printing with ink on the medium 50. In the following description, the medium 50 is a black or dark-colored fabric, but the medium 50 is not limited thereto.

The heads 10 include a first head 11 that discharges a pretreatment liquid 31 from nozzles, a second head 12 that discharges white ink 32 from nozzles, and a third head 13 that discharges colored ink other than white (referred to as “color ink 33” in the following description) from nozzles. The first head 11, the second head 12, and the third head 13 are arranged so as to be dischargeable the pretreatment liquid 31, the white ink 32, and the color ink 33 in this order onto the medium 50. The term “color ink 33” means a combination of any colored inks other than white.

The number of heads 10 (i.e., heads 11, 12. or 13) is not limited to the examples illustrated in FIGS. 1A and 1B, and may be any desired number. The number of types of colors of the third head 13 may be three or less, or five or more. Multiple heads may discharge the same color ink. Examples of the head 10 include an integrated head unit that discharges liquids of different colors from the respective nozzle rows.

The first head 11 has multiple nozzles and discharges the pretreatment liquid 31 onto the medium 50 from the nozzles. The second head 12 has multiple nozzles and discharges the white ink 32 onto the medium 50 from the nozzles. Thus, a foundation area is formed on the medium 50. The third head 13 has multiple nozzles and discharges the color ink 33 from the nozzles onto the foundation area. Thus, an image is formed on the foundation area. The image formed on the foundation area formed with the white ink 32 discharged from the second head 12 can prevent deterioration in image quality.

In the example illustrated in FIGS. 1A and 1B, the multiple carriages 20 include a first carriage 20a on which the first head 11 is mounted, a second carriage 20b on which the second head 12 is mounted, and a third carriage 20c on which the third head 13 is mounted. These carriages 20 are arranged in the order of the first carriage 20a, the second carriage 20b, and the third carriage 20c from upstream in the conveyance direction of the medium 50.

The first carriage 20a, the second carriage 20b, and the third carriage 20c are held by a guide rod 21a, a guide rod 21b, and a guide rod 21c, respectively, so as to be reciprocally movable in the main scanning direction X. The head 10 mounted on the carriage 20 moves in the main scanning direction X along with the movement of the carriage 20.

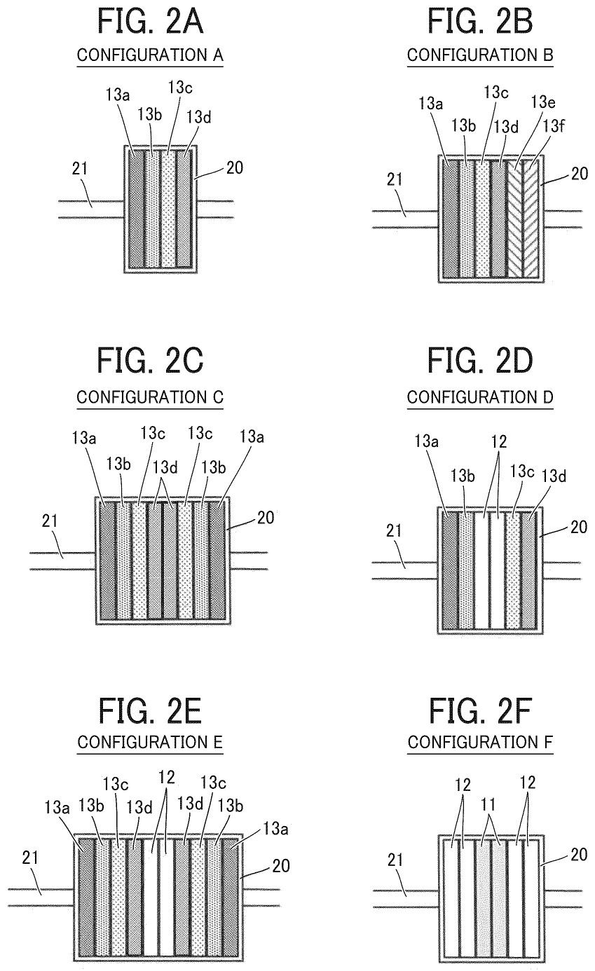

FIGS. 2A to 2F are schematic diagrams each illustrating a configuration of the multiple heads 10 mounted on the carriage 20.

The “configuration A” of FIG. 2A illustrates an example of the carriage 20 on which the heads 13 that discharge the color ink 33 are mounted. The configuration A includes a combination of heads that discharge ink for color printing. Specifically, a head 13a for cyan (C) ink, a head 13b for magenta (M) ink, a head 13c for yellow (Y) ink, and a head 13d for black (K) ink are mounted on the carriage 20. The order of arrangement of the heads is not limited to the example illustrated in FIG. 2A.

The “configuration B” of FIG. 2B illustrates an example of the carriage 20 on which the heads 13 that discharge the color ink 33 are mounted. In addition to the combination of the configuration A, heads 13e and 13f for spot color ink that discharge spot color ink (e.g., red ink and green ink) are mounted on the carriage 20. The spot color ink is not limited to any particular color, and examples of spot color include additional color inks used in commercial printing, such as blue and orange, and inks having low color density used in photographic printing, such as light magenta, light cyan, and gray, in addition to red and green. The order of arrangement of the heads is not limited to the example illustrated in FIG. 2B.

The “configuration C” of FIG. 2C illustrates an example of the carriage 20 on which the heads 13 that discharge the color ink 33 are mounted. The configuration C includes two sets of the combination of heads of the configuration A arranged symmetrically in the main scanning direction X. With this configuration, in the bidirectional printing in which the heads 13 discharge the color ink 33 in both the forward path and the backward path in the main scanning direction X, the heads 13 can discharge the color ink 33 such that the order of the colors of the color ink 33 superimposed on the medium 50 is not changed. The order of arrangement of the heads is not limited to the example illustrated in FIG. 2C as long as the heads are arranged symmetrically in the main scanning direction X.

The “configuration D” of FIG. 2D illustrates an example of the carriage 20 on which the heads 12 that discharge the white ink 32 and the heads 13 that discharge the color ink 33 are mounted. Currently, the head can be miniaturized and the nozzles can be densified, so that the heads for forming the foundation and the heads for forming the image can be integrated in the same carriage 20. In this case, the heads 12 that discharge the white ink 32 are disposed at the center of the carriage 20 so that the white ink 32 can be discharged onto the medium 50 before the color ink 33. The order of arrangement of the heads 13 that discharge the color inks 33 is not limited to the example illustrated in FIG. 2D.

The “configuration E” of FIG. 2E illustrates an example of the carriage 20 on which the heads 12 that discharge the white ink 32 and the heads 13 that discharge the color ink 33 are mounted. The heads 12 and the heads 13 are disposed symmetrically in the main scanning direction X. In the bidirectional printing, the heads 12 that discharge the white ink 32 are disposed at the center of the carriage 20 so that the white ink 32 can be discharged onto the medium 50 before the color ink 33. The order of arrangement of the heads 13 that discharge the color ink 33 is not limited to the example illustrated in FIG. 2E as long as the heads 13 are arranged symmetrically in the main scanning direction X.

The “configuration F” of FIG. 2F illustrates an example of the carriage 20 on which the heads 11 that discharge the pretreatment liquid 31 and the heads 12 that discharge the white ink 32 are mounted. In this case, the heads 11 that discharge the pretreatment liquid 31 are disposed at the center of the carriage 20 so that the pretreatment liquid 31 can be discharged onto the medium 50 before the white ink 32. With the configuration F, an image may be formed using multiple types of color inks including a spot color ink. With the carriage of the configuration F, a large number of heads 13 can be mounted on another or two or more other carriages 20.

Since the pretreatment liquid 31 and the white ink 32 are liquids that react with each other, the liquids adhering to the nozzle face may react with each other and may be fixed on the nozzle face. For this reason, the heads 11 and the heads 12 are rarely mounted on the same carriage 20 as in the configuration F. A situation such as discharge failure can be prevented by the maintenance unit 17 (see FIGS. 11A and 11B). The maintenance unit 17 scraps off the dirt adhering to the nozzle face with a wiper blade, or wipes the nozzle face with a web impregnated with a cleaning liquid to recover the condition of the nozzles.

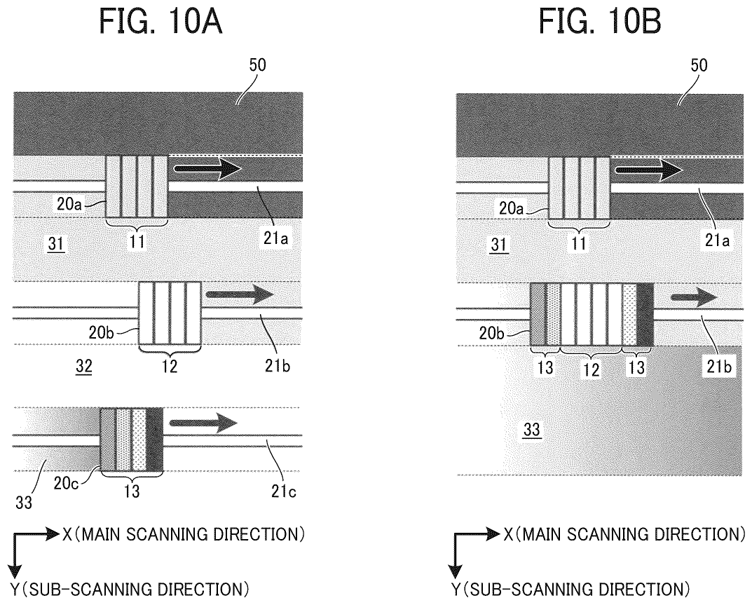

The following examples are given as the configuration of the carriage included in the DTG printer according to the present embodiment. Some examples are illustrated in FIGS. 10A to 10D.

### 1. Case of Two Carriages

a) One carriage has the configuration F, and the other carriage has the configuration A, the configuration B, or the configuration C (see FIG. 10D).
b) Only the heads 11 are mounted on one carriage, and the other carriage has the configuration D or the configuration E (see FIGS. 10B and 10C).

### 2. Case of Three Carriages

a) Only the heads 11 are mounted on a first carriage, only the heads 12 are mounted on a second carriage, and only the heads 13 are mounted on a third carriage (see FIG. 10A).
b) the first carriage has the configuration F, and only the heads 13 are mounted on the second carriage and the third carriage.
c) Only the heads 11 are mounted on a first carriage, a second carriage has the configuration D or the configuration E, and only the heads 13 are mounted on a third carriage.

FIGS. 3A to 4C are diagrams each illustrating the order of printing and a nozzle resolution of the heads. The “nozzle resolution” is an interval between adjacent nozzles (i.e., nozzle pitch), and when an image is formed by one pass, the nozzle resolution is equal to the nozzle pitch. The unit of resolution is dots per inch (dpi). The nozzle pitch is a value fixed at the time of manufacturing. The nozzle resolution is a value that can be changed by the arrangement of the heads.

The liquids are discharged onto the medium in the order of the pretreatment liquid, the white ink, and the color ink. In other words, printing is performed in the order of printing by the heads 11, printing by the heads 12, and printing by the heads 13. The head 11 has nozzles 41 from which the pretreatment liquid is discharged, the head 12 has nozzles 42 from which the white ink is discharged, and the head 13 has nozzles 43 from which the color ink is discharged.

FIGS. 3A to 3C illustrate an example of printing using heads having the same nozzle pitch. The pitch of the nozzles 41 of the head 11, the pitch of the nozzles 42 of the head 12, and the pitch of the nozzles 43 of the head 13 are identical before assembly of the heads. The nozzle resolution of the assembled heads 11 is increased by shifting the assembly positions of the heads 11, and the nozzle resolution of the assembled heads 12 is increased by shifting the assembly positions of the heads 12.

On the other hand, FIGS. 4A to 4C illustrate an example of printing using the head 11, the head 12, and the head 13 having different nozzle pitches. Since the pretreatment liquid, the white ink, and the color ink have different physical properties (e.g., viscosity, dispersibility of components, and liquid contact property with components of the head), a head suitable for liquid discharge of each of the inks and liquids may be selected. At this time, as illustrated in FIGS. 4A to 4C, when the heads are different from each other in size, the head preferably has a region which is not used as illustrated in FIGS. 4A and 4B.

When an upstream head is disposed upstream from a downstream head in the direction in which the medium 50 is conveyed (i.e., the sub-scanning direction Y) and has a higher nozzle resolution than the downstream head, the downstream head, which discharges liquid after the upstream head, can discharge the liquid within an area where the upstream head has previously discharged liquid. In addition, a discharge failure can be prevented in which the droplets of the liquid discharged from the downstream head deviate from the desired landing position due to factors such as oblique discharge or variation in the amount of liquid droplets. Such a discharge failure may be called undesired permeation.

As illustrated in FIGS. 3A to 4C, the DTG printer according to the present embodiment satisfies the relationship of N1≥N2≥N3, where N3 represents the nozzle resolution of the head 11 (first head) that discharges the pretreatment liquid, N2 represents the nozzle resolution of the head 12 (second head) that discharges the white ink, and N3 represents the nozzle resolution of the head 13 (third head) that discharges the color ink, and also satisfies the relationships of N1/N3=m, N2/N3=n, and m≥n (m and n are integers equal to or greater than 1).

The nozzle resolution N1 of the head 11 for discharging the pretreatment liquid and the nozzle resolution N2 of the head 12 for discharging the white ink, which forms the foundation, are set with reference to the nozzle resolution N3 of the head 13 for discharging the color ink, which forms an image. The head 11 and the head 12 are disposed upstream from the head 13 in the sub-scanning direction. Each of the nozzle resolution N1 and the nozzle resolution N2 is an integral multiple of the nozzle resolution N3. Accordingly, data of droplets of liquid to be discharged can be created by a simple enlargement process (e.g., the same data is simply copied).

On the other hand, when the nozzle resolutions N1 and N2 are not integral multiples of the nozzle resolution N3, different image enlargement processes or image processing may be performed on data for the pretreatment liquid, the white ink, and the color ink, respectively. As a result, the calculation load may increase and the productivity may decrease.

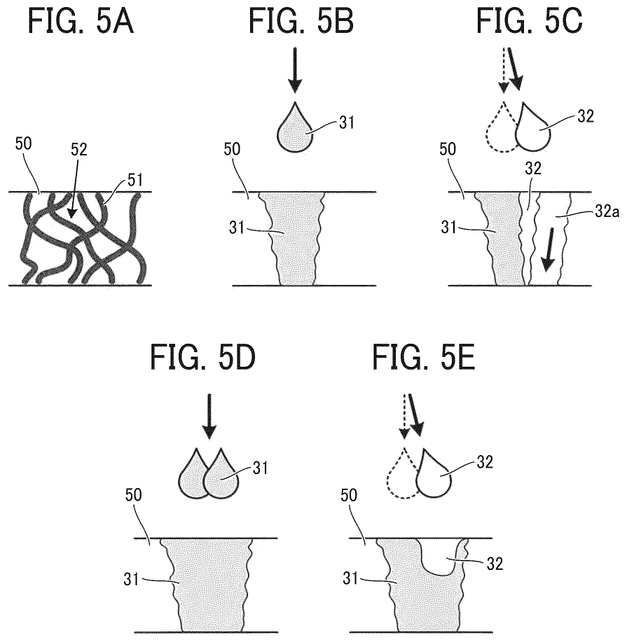

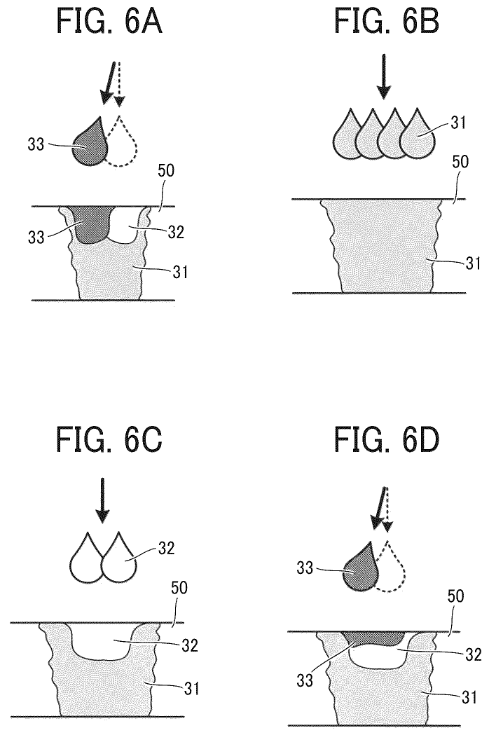

FIGS. 5A to 6D are schematic diagrams each illustrating a process of permeation of liquid discharged onto a medium. As illustrated in FIG. 5A, the fabric as the medium 50 has voids 52 between intertwined fibers 51. Accordingly, as illustrated in FIG. 5B, the discharged pretreatment liquid 31 permeates into the inside of the medium 50 without spreading on the surface of the medium 50. The white ink 32 which is subsequently discharged reacts with the pretreatment liquid 31 which is previously discharged. As a result, the white ink 32 is solidified.

However, if the oblique discharge of the head 12 due to a discharge defective nozzle occur, as illustrated in FIG. 5C, the white ink 32 may not be discharged within the area where the pretreatment liquid 31 has been applied. If the white ink 32 discharged outside the area where the pretreatment liquid 31 has been applied is not solidified on and near the surface of the medium 50, and permeates into the medium 50, undesired permeation 32a of the white ink 32 occurs as illustrated in FIG. 5C, and thus a missing foundation area appears in the foundation area.

By contrast, in the DTG printer according to the present embodiment, the head 11 (first head) that discharges the pretreatment liquid has the nozzle resolution N1 higher than the nozzle resolution N2 of the head 12 (second head) that discharges the white ink. As a result, the area where the pretreatment liquid 31 is applied can be widened as illustrated in FIGS. 5D and 5E, and the white ink 32 can be prevented from deviating from the application area of the pretreatment liquid 31.

On the other hand, when the color ink 33 is discharged onto the medium 50 in the state illustrated in FIG. 5E, if the oblique discharge due to the discharge defective nozzle occurs in the head 13, the color ink 33 may not be discharged into the foundation area formed of the white ink 32 as illustrated in FIG. 6A. The color ink 33 discharged outside the foundation area permeates into the medium 50, and thus the coloring of the color ink 33 may deteriorate and the fixability of the image may also deteriorate. In addition, when the white color of the foundation area where the color ink 33 is not discharged is exposed on the surface of the medium 50, the white color causes noise in the image, and thus the image quality may deteriorate.

By contrast, in the DTG printer according to the present embodiment, the nozzle resolution N1 of the head 11 (first head) for discharging the pretreatment liquid 31, the nozzle resolution N2 of the head 12 (second head) for discharging the white ink 32, and the nozzle resolution N3 of the head 13 (third head) for discharging the color ink 33 are set to satisfy at least the relationship N1≥N2≥N3. As a result, as illustrated in FIGS. 6B, 6C, and 6D, the foundation area of the white ink 32 is formed in the application area of the pretreatment liquid 31, and the color ink 33 can be prevented from being discharged outside the foundation area.

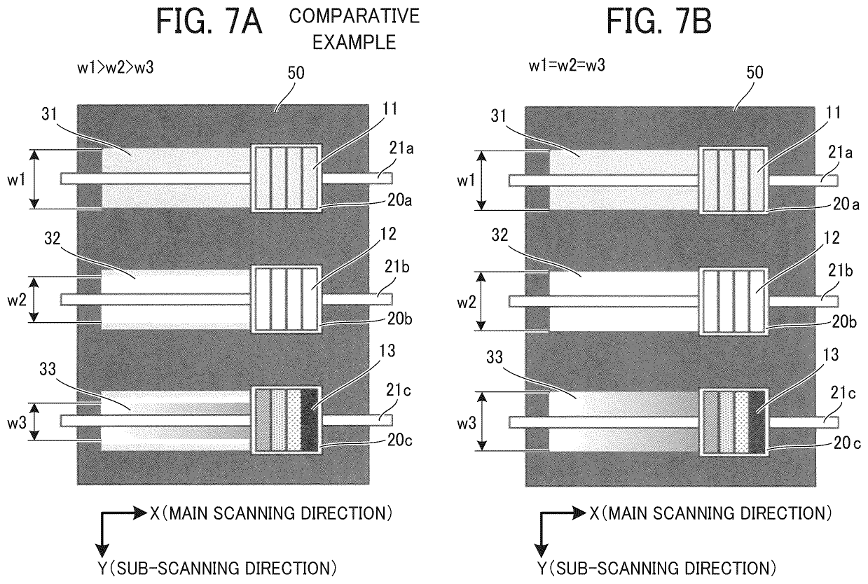

FIGS. 7A and 7B are diagrams each illustrating the operation of the line feed and the amount of the line feed in a printing process. The heads 10 are arranged so as to discharge the pretreatment liquid 31, the white ink 32, and the color ink 33 in this order onto the medium 50. Thus, the DTG printer can sequentially perform the printing of the pretreatment liquid 31, the printing of the white ink 32, and the printing of the color ink 33 in accordance with the conveyance of the medium 50.

For example, a typical line type printer controls print start timing and a discharge frequency in accordance with the conveyance speed of the medium 50 to perform high-resolution printing even when the print resolution of the respective heads 10 are different.

On the other hand, the serial type DTG printer according to the present embodiment performs high-resolution printing by multi-pass printing (multi-pass recording) in which the carriage 20 moves multiple times in the main scanning direction at each position of the medium 50. The amount of line feed per one movement of the carriage 20 takes various values depending on the nozzle pitch and the number of nozzles of each head 10 and the sequence of the multi-pass printing. Accordingly, it is difficult to sequentially perform the printings in accordance with the conveyance of the medium 50 only by arranging the heads 10 so as to discharge the pretreatment liquid 31, the white ink 32, and the color ink 33 in this order.

For example, as illustrated in FIG. 7A, when an amount of line feed W is different between the heads 10 (i.e., the heads 11, 12, and 13) mounted on the carriages 20 (i.e., the carriages 20a, 20b, and 20c) (e.g., w1>w2>w3), the head 11 (the carriage 20a) with the amount of line feed w1 generates an overlapping region of printing, and the head 13 (the carriage 20c) with the amount of line feed w3 generates a missing region in which the printing is not performed.

In a printer according to a comparative example, after the pretreatment liquid 31 is applied onto the entire surface of the medium 50, the medium 50 is conveyed backward (reloaded), and then the printing of the white ink 32 is performed. After that, the medium 50 is conveyed backward again, and then the printing of the color ink 33 is performed. However, such a printing method takes a long time to complete printing, and thus it is difficult to increase productivity.

By contrast, since the amounts of line feed W in the respective heads 10 (the respective carriages 20) are identical (i.e., w1=w2=w3) as illustrated in FIG. 7B, the DTG printer according to the present embodiment can consecutively apply the pretreatment liquid 31, form the foundation with the white ink 32, and print with the color ink 33 at once without conveying the medium 50 backward (i.e., the reload of the medium 50).

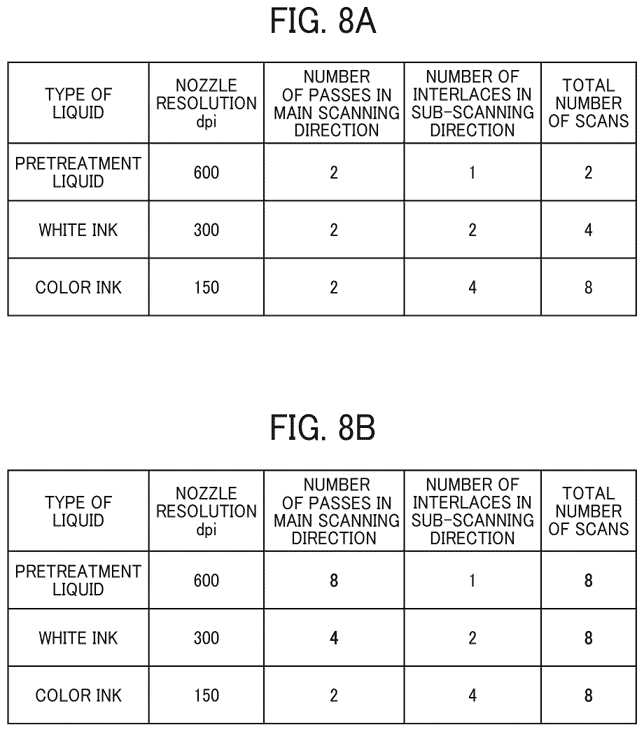

FIGS. 8A and 8B are tables in which the amounts of line feed match each other in the sequence of the multi-pass recording using heads having different nozzle resolutions. As an example, printing of 600 dpi×600 dpi is illustrated in FIGS. 8A and 8B.

The high-resolution printing is performed with a large number of movements (the number of passes in the main scanning direction x the number of interlaces in the sub-scanning direction). When the heads 10 have different nozzle resolutions, the nozzle resolutions of the heads 10 preferably have a relationship of integral multiples to make the amounts of line feed of the heads 10 identical.

In other words, the nozzle resolution N1 of the head 11 (first head) that discharges the pretreatment liquid 31, the nozzle resolution N2 of the head 12 (second head) that discharges the white ink 32, and the nozzle resolution N3 of the head 13 (third head) that discharges the color ink 33 preferably satisfy the following relationships: N1/N3=m, N2/N3=n, and m≥ n (m and n are integers equal to or greater than 1). In other words, the nozzle resolution of each of the upstream heads (head 11 and head 12) is a common multiple of the nozzle resolution of the most downstream head (head 13).

Accordingly, the number of passes in the main scanning direction is set to h times (h is an integer), and thus the amount of line feed can be adjusted to 1/h times. In the example of FIGS. 8A and 8B, the number of passes of the head 11, which discharges the pretreatment liquid, in the main scanning direction is multiplied by 4, and the number of passes of the head 12, which discharges the white ink, in the main scanning direction is multiplied by 2 as illustrated from FIG. 8A to FIG. 8B, to make the amount of line feed of each the head 11 and the head 12 match the amount of line feed of the head 13 which discharges the color ink.

When surplus nozzles are generated, these nozzles are not used to match the sizes of the heads 10 each other (see FIGS. 4A to 4C). By making the total number of movements (scans) identical as illustrated in FIG. 8B, the printing operations of the heads 10 can match even when the heads 10 having different nozzle resolutions are mounted on the same carriage 20.

When very high-resolution printing is performed, if the nozzle resolution of each head 10 is not an integral multiple of the nozzle resolution of the reference head 10, the number of nozzles used, the number of passes in the main scanning direction, and the number of interlaces in the sub-scanning direction may be adjusted to approximate the amount of line feed. However, if the amounts of line feed do not completely match, an error corresponding to one pitch (for example, 21 μm in the nozzle resolutions of 1200 dpi) may occur. Due to this error, white streaks (missing streaks) or black streaks (dark streaks due to overlapping droplet discharge) may be formed in the main scanning direction, and thus the image quality may deteriorate.

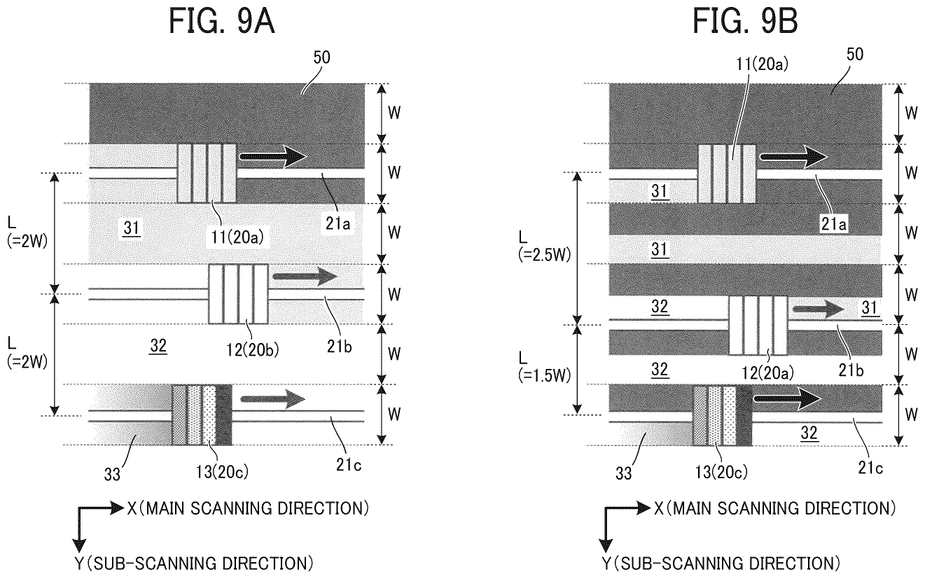

FIGS. 9A and 9B are diagrams illustrating the relationship between the amount of line feed W and an arrangement interval L of the heads 10 (the carriages 20). The arrangement interval is a distance between the centers of the heads 10 (the carriages 20) in the sub-scanning direction Y. To consecutively perform the pretreatment, the foundation formation, and the color printing with high resolution, the arrangement interval of the heads 10 (the carriages 20) is adjusted in addition to the above-described conditions.

FIG. 9A illustrates an example in which the heads 10 (the carriages 20) are arranged such that the arrangement interval L between the heads 10 (the carriages 20) is an integral multiple of the amount of line feed W of the head 13 which discharges the color ink 33. On the other hand, FIG. 9B illustrates an example in which the arrangement interval L of the heads 10 (the carriages 20) is not an integral multiple of the amount of line feed W of the head 13 which discharges the color ink 33.

In the example of FIG. 9A, the arrangement interval between the head 11 (carriage 20a) and the head 12 (carriage 20b) and the arrangement interval between the head 12 (carriage 20b) and the head 13 (carriage 20c) have a relationship of L=2W. Since the arrangement interval L is an integral multiple of the amount of line feed W (in a relationship of a common multiple), even when the line feed operation is repeated, the printing position and the position of the head (carriage) coincide with each other.

On the other hand, in the example of FIG. 9B, the arrangement interval between the head 11 (carriage 20a) and the head 12 (carriage 20b) and the arrangement interval between the head 12 (carriage 20b) and the head 13 (carriage 20c) have relationships of L=2.5W and L=1.5W, respectively. Since the arrangement interval L is not an integral multiple of the amount of line feed W, the printing position and the position of the head (carriage) do not coincide with each other due to the repetition of the line feed operation, and an area where printing is not performed is generated.

In the example of FIG. 9B, although the two arrangement intervals L are not integral multiples of the amount of line feed W, since the difference of the arrangement interval L from the integral multiple is ½ of the amount of line feed W, the multi-pass recording with ½ of the amount of line feed can perform a complete image formation. As described above, when the arrangement interval L is not an integral multiple of the amount of line feed W, it is difficult to perform the complete image formation.

As in the example of FIG. 9A, the arrangement interval L of each head 10 (each carriage 20) set to be an integral multiple of the amount of line feed W allows a higher printing mode (high image quality mode). Typically, the resolution of printing in the high image quality mode is twice the resolution of printing in a standard mode. To double the resolution in the conveyance direction, the number of interlaces is doubled and the amount of line feed is set to ½, and if the arrangement interval of the heads 10 (carriages 20) is an integral multiple of the amount of line feed, the pretreatment, the foundation formation, and the color printing can be consecutively performed at once.

As the configuration of the multiple heads 10 mounted on the carriage 20, when the head 12 that discharges the white ink 32 and the head 13 that discharges the color ink 33 are mounted on the same carriage 20 as in the configuration D of FIG. 2D and the configuration E of FIG. 2E, the arrangement distance L between the head 12 and the head 13 can be regarded as 0. When the head 11 that discharges the pretreatment liquid 31 and the head 12 that discharges the white ink 32 are mounted on the same carriage 20 as in the configuration F of FIG. 2F, the arrangement distance L between the head 11 and the head 12 can be regarded as 0.

With these configurations, the head disposed at the center of the carriage is controlled so as to discharge first to maintain the order of discharge (the order of the pretreatment liquid, the white ink, and the color ink) onto the medium 50. Specifically, in the bidirectional printing, the heads that discharge liquids are switched between the movement in the forward path and the movement in the backward path to adjust the order of discharge.

As described above, the DTG printer according to the present embodiment is a serial type liquid discharge apparatus that can consecutively perform pretreatment, foundation formation, and color printing by a single integrated apparatus. The DTG printer includes the first head 11 that discharges the pretreatment liquid 31 from the nozzles, the second head 12 that discharges the white ink 32 from the nozzles, and the third head 13 that discharges the colored ink other than white ink (color ink 33) from the nozzles. The first head 11, the second head 12, and the third head 13 are arranged so as to be dischargeable the pretreatment liquid 31, the white ink 32, and the color ink 33 in this order onto the medium 50. When N1 represents the nozzle resolution of the first head 11, N2 represents the nozzle resolution of the second head 12, and N3 represents the nozzle resolution of the third head 13, the relationships of N1≥N2≥N3, N1/N3=m, N2/N3=n, and m≥n (m and n are integers equal to or greater than 1) are satisfied.

In the DTG printer according to the present embodiment, when W represents a movement distance per one time of the medium 50 moved by the platen 61 in the sub-scanning direction Y in response to the movement (scan) of the third head 13, L1 represents an arrangement interval between the first head 11 and the second head 12 in the sub-scanning direction Y, and L2 represents an arrangement interval between the second head 12 and the third head 13 in the sub-scanning direction Y, the relationships of L1=W×p and L2=W×q (p and q are integers equal to or greater than 0) are satisfied.

In a first mode (FIG. 10A), the DTG printer according to the present embodiment includes three carriages. The three carriages include the first carriage 20a on which the first head 11 is mounted, the second carriage 20b on which the second head 12 is mounted, and the third carriage 20c on which the third head 13 is mounted. These carriages are arranged in the order of the first carriage 20a, the second carriage 20b, and the third carriage 20c from upstream in the conveyance direction of the medium 50.

When L3 represents the arrangement interval between the first carriage 20a and the second carriage 20b in the sub-scanning direction Y, and L4 represents the arrangement interval between the second carriage 20b and the third carriage 20c in the sub-scanning direction Y, the relationships of L3=W×r and L4=W×s (r and s are integers equal to or greater than 1) are satisfied.

In a second mode, the DTG printer according to the present embodiment includes three carriages. The three carriages include the first carriage 20a on which only the first head 11 is mounted, the second carriage 20b on which the second head 12 and the third head 13 are mounted, and the third carriage 20c on which only the third head 13 is mounted. These carriages are arranged in the order of the first carriage 20a, the second carriage 20b, and the third carriage 20c from upstream in the conveyance direction of the medium 50.

When L3 represents the arrangement interval between the first carriage 20a and the second carriage 20b in the sub-scanning direction Y, and L4 represents the arrangement interval between the second carriage 20b and the third carriage 20c in the sub-scanning direction Y, the relationships of L3=W×r and L4=W×s (r and s are integers equal to or greater than 1) are satisfied. With such a configuration, heads for various kinds of color inks can be mounted.

In a third mode, the DTG printer according to the present embodiment includes three carriages. The three carriages include the first carriage 20a on which the first head 11 and the second head 12 are mounted, the second carriage 20b on which only the third head 13 is mounted, and the third carriage 20c on which only the third head 13 is mounted. These carriages are arranged in the order of the first carriage 20a, the second carriage 20b, and the third carriage 20c from upstream in the conveyance direction of the medium 50.

When L3 represents the arrangement interval between the first carriage 20a and the second carriage 20b in the sub-scanning direction Y, and L4 represents the arrangement interval between the second carriage 20b and the third carriage 20c in the sub-scanning direction Y, the relationships of L3=W×r and L4=W×s (r and s are integers equal to or greater than 1) are satisfied. With this configuration, heads for multiple, various kinds of color inks can be mounted.

In a fourth mode (FIGS. 10B and 10C), the DTG printer according to the present embodiment includes two carriages. The two carriages include the first carriage 20a on which only the first head 11 is mounted and the second carriage 20b on which the second head 12 and the third head 13 are mounted. These carriages are arranged in the order of the first carriage 20a and the second carriage 20b from upstream in the conveyance direction of the medium 50.

When L5 represents the arrangement interval between the first carriage 20a and the second carriage 20b in the sub-scanning direction Y, the relationship L5=W×t (t is an integer equal to or greater than 1) is satisfied. The DTG printer including the two carriages can reduce the length of the apparatus in the sub-scanning direction Y. As a result, the apparatus can be miniaturized to save space.

In a fifth mode (FIG. 10D), the DTG printer according to the present embodiment includes two carriages. The two carriages include the first carriage 20a on which the first head 11 and the second head 12 are mounted and the second carriage 20b on which the third head 13 is mounted. These carriages are arranged in the order of the first carriage 20a and the second carriage 20b from upstream in the conveyance direction of the medium 50.

When L5 represents the arrangement interval between the first carriage 20a and the second carriage 20b in the sub-scanning direction Y, the relationship L5=W×t (t is an integer equal to or greater than 1) is satisfied. The DTG printer including the two carriages can reduce the length of the apparatus in the sub-scanning direction Y. As a result, the apparatus can be miniaturized to save space.

The DTG printer according to the present embodiment can consecutively perform the pretreatment, the foundation formation, and the color printing at once as a single integrated apparatus. Further, the robustness of images and image quality can be enhanced. Although the DTG printer has been described as the embodiments of the present disclosure, the liquid discharge apparatus according to embodiments of the present disclosure is not limited thereto. The medium is not limited to fabric such as a garment as long as liquid can be adhered thereto, and other materials can be selected.

Aspects of the present disclosure are, for example, as follows.

### Aspect 1

A liquid discharge apparatus includes multiple heads, multiple carriages, and a conveyor. The multiple heads discharge a liquid onto a medium. The heads are mounted on the multiple carriages. The multiple carriages reciprocally move in a main scanning direction. The conveyor intermittently conveys the medium in a sub-scanning direction in response to a movement (scan) of the heads. The heads include a first head that discharges a pretreatment liquid from nozzles, a second head that discharges a white ink from nozzles, and a third head that discharges a colored ink other than white ink from nozzles. The first head, the second head, and the third head are arranged so as to be dischargeable the pretreatment liquid, the white ink, and the colored ink in this order onto the medium. When N1 represents the nozzle resolution of the first head, N2 represents the nozzle resolution of the second head, and N3 represents the nozzle resolution of the third head, the relationships of N1≥N2≥N3, N1/N3=m, N2/N3=n, and m≥n (m and n are integers equal to or greater than 1) are satisfied. When W represents an amount of line feed per movement of the medium moved by the conveyor in the sub-scanning direction in response to the movement (scan) of the third head, L1 represents an arrangement interval between the first head and the second head in the sub-scanning direction, and L2 represents an arrangement interval between the second head and the third head in the sub-scanning direction, the relationships of L1=W×p and L2=W×q (p and q are integers equal to or greater than 0) are satisfied.

In other words, a liquid discharge apparatus includes multiple heads, multiple carriages, and a conveyor. The multiple heads include a first head to discharge a pretreatment liquid from first nozzles onto a medium in a first nozzle resolution N1; a second head to discharge a white ink from second nozzles onto the medium, onto which the pretreatment liquid has been discharged, in a second nozzle resolution N2; and a third head to discharge a color ink other than white from third nozzles onto the medium, onto which the pretreatment liquid and the white ink have been discharged, in a third nozzle resolution N3. Expressions of N1≥N2≥N3, N1/N3=m, N2/N3=n, and m≥n are satisfied, and m and n are integers equal to or greater than 1. The multiple carriages mount the multiple heads and reciprocally movable in a main scanning direction. The conveyor intermittently conveys the medium by an amount of line feed W of the medium in a sub-scanning direction orthogonal to the main scanning direction in response to one movement of the third head in the main scanning direction. The first head is arranged at a first distance L1 from the second head in the sub-scanning direction, and the second head is arranged at a second distance L2 from the third head in the sub-scanning direction. Expressions of L1=W×p, and L2=W×q are satisfied, and p and q are integers equal to or greater than 0.

### Aspect 2

In the liquid discharge apparatus according to Aspect 1, the multiple carriages include a first carriage on which the first head is mounted, a second carriage on which the second head is mounted, and a third carriage on which the third head is mounted. These carriages are arranged in the order of the first carriage, the second carriage, and the third carriage from upstream in the conveyance direction of the medium. When L3 represents the arrangement interval between the first carriage and the second carriage in the sub-scanning direction, and L4 represents the arrangement interval between the second carriage and the third carriage in the sub-scanning direction, the relationships of L3=W×r and L4=W×s (r and s are integers equal to or greater than 1) are satisfied.

In other words, the multiple carriages include a first carriage mounting the first head, a second carriage mounting the second head, and a third carriage mounting the third head. The first carriage, the second carriage, and the third carriage are arranged in this order from upstream in the sub-scanning direction. The first carriage is arranged at a third distance L3 from the second carriage in the sub-scanning direction, and the second carriage is arranged at a fourth distance L4 from the third carriage in the sub-scanning direction. Expressions of L3=W×r and L4=W×s are satisfied, and r and s are integers equal to or greater than 1.

### Aspect 3

In the liquid discharge apparatus according to Aspect 1, the multiple carriages include a first carriage on which only the first head is mounted, a second carriage on which the second head and the third head are mounted, and a third carriage on which the third head is mounted. These carriages are arranged in the order of the first carriage, the second carriage, and the third carriage from upstream in the conveyance direction of the medium. When L3 represents the arrangement interval between the first carriage and the second carriage in the sub-scanning direction, and L4 represents the arrangement interval between the second carriage and the third carriage in the sub-scanning direction, the relationships of L3=W×r and L4=W×s (r and s are integers equal to or greater than 1) are satisfied.

In other words, the multiple carriages include a first carriage mounting the first head, a second carriage mounting the second head and the third head, and a third carriage mounting the third head. The first carriage, the second carriage, and the third carriage are arranged in this order from upstream in the sub-scanning direction. The first carriage is arranged at a third distance L3 from the second carriage in the sub-scanning direction, and the second carriage is arranged at a fourth distance L4 from the third carriage in the sub-scanning direction. Expressions of L3=W×r and L4=W×s are satisfied, and r and s are integers equal to or greater than 1.

### Aspect 4

In the liquid discharge apparatus according to Aspect 1, the multiple carriages include a first carriage on which the first head and the second head are mounted, a second carriage on which the third head is mounted, and a third carriage on which the third head is mounted. These carriages are arranged in the order of the first carriage, the second carriage, and the third carriage from upstream in the conveyance direction of the medium. When L3 represents the arrangement interval between the first carriage and the second carriage in the sub-scanning direction, and L4 represents the arrangement interval between the second carriage and the third carriage in the sub-scanning direction, the relationships of L3=W×r and L4=W×s (r and s are integers equal to or greater than 1) are satisfied.

In other words, the multiple carriages include a first carriage mounting the first head and the second head, a second carriage mounting the third head, and a third carriage mounting the third head. The first carriage, the second carriage, and the third carriage are arranged in this order from upstream in the sub-scanning direction. The first carriage is arranged at a third distance L3 from the second carriage in the sub-scanning direction, and the second carriage is arranged at a fourth distance L4 from the third carriage in the sub-scanning direction. Expressions of L3=W×r and L4=W×s are satisfied, and r and s are integers equal to or greater than 1.

### Aspect 5

In the liquid discharge apparatus according to Aspect 1, the multiple carriages include a first carriage on which the first head is mounted and a second carriage on which the second head and the third head are mounted. These carriages are arranged in the order of the first carriage and the second carriage from upstream in the conveyance direction of the medium. When L5 represents the arrangement interval between the first carriage and the second carriage in the sub-scanning direction, the relationship of L5=W×t (t is an integer equal to or greater than 1) is satisfied.

In other words, the multiple carriages include a first carriage mounting the first head, and a second carriage mounting the second head and the third head. The first carriage and the second carriage are arranged in this order from upstream in the sub-scanning direction. The first carriage is arranged at a third distance L3 from the second carriage in the sub-scanning direction. An expression of L3=W×r is satisfied, and r is an integer equal to or greater than 1.

### Aspect 6

In the liquid discharge apparatus according to Aspect 1, the multiple carriages include a first carriage on which the first head and the second head are mounted and a second carriage on which the third head is mounted. These carriages are arranged in the order of the first carriage and the second carriage from upstream in the conveyance direction of the medium. When L5 represents the arrangement interval between the first carriage and the second carriage in the sub-scanning direction, the relationship of L5=W×t (t is an integer equal to or greater than 1) is satisfied.

In other words, the multiple carriages include a first carriage mounting the first head and the second head, and a second carriage mounting the third head. The first carriage and the second carriage are arranged in this order from upstream in the sub-scanning direction. The first carriage is arranged at a third distance L3 from the second carriage in the sub-scanning direction. An expression of L3=W×r is satisfied, and r is an integer equal to or greater than 1.

As described above, according to one aspect of the present disclosure, a serial type liquid discharge apparatus as a single integrated apparatus can be provided that consecutively applies the pretreatment liquid, forms the foundation with the white ink, and prints with the color ink.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge apparatus comprising:
multiple heads including:
a first head to discharge a pretreatment liquid from first nozzles onto a medium in a first nozzle resolution N1;
a second head to discharge a white ink from second nozzles onto the medium, onto which the pretreatment liquid has been discharged, in a second nozzle resolution N2; and
a third head to discharge a color ink other than white from third nozzles onto the medium, onto which the pretreatment liquid and the white ink have been discharged, in a third nozzle resolution N3,
where expressions of N1≥N2≥N3, N1/N3=m, N2/N3=n, and m≥n are satisfied, and m and n are integers equal to or greater than 1;
multiple carriages mounting the multiple heads and reciprocally movable in a main scanning direction; and
a conveyor to intermittently convey the medium by an amount of line feed W of the medium in a sub-scanning direction orthogonal to the main scanning direction in response to one movement of the third head in the main scanning direction,
wherein the first head is arranged at a first distance L1 from the second head in the sub-scanning direction, and
the second head is arranged at a second distance L2 from the third head in the sub-scanning direction,
where expressions of L1=W×p, and L2=W×q are satisfied, and p and q are integers equal to or greater than 0.

2. The liquid discharge apparatus according to claim 1,
wherein the multiple carriages include:
a first carriage mounting the first head;
a second carriage mounting the second head; and
a third carriage mounting the third head,
the first carriage, the second carriage, and the third carriage are arranged in this order from upstream in the sub-scanning direction,
the first carriage is arranged at a third distance L3 from the second carriage in the sub-scanning direction, and
the second carriage is arranged at a fourth distance L4 from the third carriage in the sub-scanning direction,
where expressions of L3=W×r and L4=W×s are satisfied, and r and s are integers equal to or greater than 1.

3. The liquid discharge apparatus according to claim 1,
wherein the multiple carriages include:
a first carriage mounting the first head;
a second carriage mounting the second head and the third head; and
a third carriage mounting the third head,
the first carriage, the second carriage, and the third carriage are arranged in this order from upstream in the sub-scanning direction,
the first carriage is arranged at a third distance L3 from the second carriage in the sub-scanning direction, and
the second carriage is arranged at a fourth distance LA from the third carriage in the sub-scanning direction,
where expressions of L3=W×r and L4=W×s are satisfied, and r and s are integers equal to or greater than 1.

4. The liquid discharge apparatus according to claim 1,
wherein the multiple carriages include:
a first carriage mounting the first head and the second head;
a second carriage mounting the third head; and
a third carriage mounting the third head,
the first carriage, the second carriage, and the third carriage are arranged in this order from upstream in the sub-scanning direction,
the first carriage is arranged at a third distance L3 from the second carriage in the sub-scanning direction, and
the second carriage is arranged at a fourth distance LA from the third carriage in the sub-scanning direction,
where expressions of L3=W×r and L4=W×s are satisfied, and r and s are integers equal to or greater than 1.

5. The liquid discharge apparatus according to claim 1,
wherein the multiple carriages include:
a first carriage mounting the first head; and
a second carriage mounting the second head and the third head,
the first carriage and the second carriage are arranged in this order from upstream in the sub-scanning direction, and
the first carriage is arranged at a third distance L3 from the second carriage in the sub-scanning direction,
where an expression of L3=W×r is satisfied, and r is an integer equal to or greater than 1.

6. The liquid discharge apparatus according to claim 1,
wherein the multiple carriages include:
a first carriage mounting the first head and the second head; and
a second carriage mounting the third head,
the first carriage and the second carriage are arranged in this order from upstream in the sub-scanning direction, and
the first carriage is arranged at a third distance L3 from the second carriage in the sub-scanning direction,
where an expression of L3=W×r is satisfied, and r is an integer equal to or greater than 1.
